(19) United States
(12) Patent Application Publication
(10) Pub. No.: US 2007/0177721 A1
(43) Pub. Date: Aug. 2, 2007

(54) Tamper-proof elliptic encryption with private key

(75) Inventors: Kouichi Itoh, Kawasaki (JP); Tetsuya Izu, Kawasaki (JP); Masahiko Takenaka, Kawasaki (JP); Naoya Torii, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/272,916

(22) Filed: Nov. 15, 2005

Related U.S. Application Data
(63) Continuation of application No. PCT/JP03/09284, filed on Jul. 22, 2003.

(51) Int. Cl. H04L 9/28

(52) U.S. Cl. 380/28

(57) ABSTRACT

An encryption device (10) for performing elliptic encryption processing with a private key, includes: randomizing means (16) for setting, into an initial elliptic point V₀, an elliptic point R on an elliptic curve that is generated in accordance with a random value; operation means (20) for performing a first operation of summing the initial elliptic point V₀ and a scalar multiple of a particular input elliptic point A on the elliptic curve, V₁=V₀+dA, in accordance with a bit sequence of a particular scalar value d for the elliptic encryption processing; de-randomizing means (22) for performing a second operation of subtracting the initial elliptic point V₀ from the sum V₁ determined by the first operation, V=V₁−V₀; and means (24) for providing, as an output, the elliptic point V determined by the de-randomization unit.

### FIELD OF THE INVENTION

The present invention relates generally to the field of cryptography, and more particularly to tamper-proof encryption/decryption with provisions for preventing power analysis attacks, such as SPA, DPA and RPA, in a processor for elliptic curve cryptosystem.

### BACKGROUND OF THE INVENTION

Services provided over networks are spreading widely, as exemplified by the electronic payment over the network, and the Japanese Resident Registration Network. These services use encryption for information security.

The smart card that contains an IC chip for storing user's secret information is expected to spread widely as a user device in such services. The smart card has the functions of encryption, digital signature and authentication, and uses its secret information as a key. Since such secret information is stored in the IC chip memory, the smart card achieves significantly high security or tamper resistance against unauthorized access by a third party, in comparison with a magnetic card.

FIG. 1 shows an example of the configuration of encryption/decryption with a secret key in an encryption device, such as a smart card. In FIG. 1, the encryption device processes an input plaintext/ciphertext message with a private key in its encryption/decryption unit, in a well known manner, to provide an output ciphertext/plaintext message. Cryptosystems generally includes a public key cryptosystem and a common key cryptosystem.

The public key cryptosystem uses different keys for decryption and encryption, respectively. Typically, a plaintext is encrypted with a public key, and a ciphertext is decrypted with a private or secret key, to thereby provide secure transmission of the ciphertext. In addition, the plaintext may be encrypted with a private key, and the ciphertext may be decrypted with a public key, to thereby identify the user who has encrypted the plaintext, for digital signature and authentication. In the public key cryptosystem, no secret key is required to be shared by the transmitter and the receiver, but its amount of computation is much larger than the common key cryptosystem. The public key cryptosystem includes the RSA encryption and the elliptic curve encryption.

The RSA encryption is based on modular exponentiation expressed by z=a^{x} (mod n). The cryptographic function based on the RSA encryption is related to encryption, decryption, signature generation, and signature verification. In the decryption and signature generation, user's secret information is used as a private key. The modular exponentiation generates output data v that satisfies v=a^{d} (mod n), where a denotes input data, mod n denotes modulo n for the remainder, and d denotes a private key.

The elliptic curve encryption is based on elliptic point scalar multiplication. The elliptic point scalar multiplication generates a point V that satisfies V=dA for a scalar value d and a point A on an elliptic curve. The cryptographic function based on the elliptic curve encryption is related to ECES encryption/decryption, ECDSA signature generation/signature verification, and ECDH secret key sharing. In the processing of ECES decryption, ECDSA signature generation, and ECDH secret key sharing, user's secret information is used as a private key. For example, in the processing for the shared ECDH secret key, the elliptic point scalar multiplication expressed by V=dA is performed to determine an elliptic point V expressing a shared secret value, where A denotes the point of a public key paired with the shared secret key, and d denotes the scalar value of the private key.

The modular multiplication c=a×b (mod n), the modular squaring c=a², and the modular exponentiation C=a^{x} (mod n) in the RSA encryption correspond to the elliptic point addition C=A+B, the elliptic point doubling C=2A, and the elliptic point scalar multiplication C=×A in the elliptic curve encryption, respectively.

Analysis for decryption or tampering is attempted by guessing secret information, including the secret key, from available information such as ciphertext. Power analysis attack which is one form of decryption was devised in 1998 by Paul Kocher.

The power analysis attack is described in P. Kocher, J. Jaffe and B. Jun “Differential Power Anaysis”, Crypto '99, LNCS 1666, pp. 388-397, Springer-Verlag, 1999.

In this power analysis attack, different pieces of input data are provided to the encryption processor included in an encryption device, such as a smart card. During this process, changes in power dissipation over time are measured using an oscilloscope or the like, for example, as shown in FIG. 1, and a statistically sufficient number of power dissipation curves are collected and analyzed to guess key information held within the encryption processor. This power analysis attack can be applied to both of the common key cryptosystem and the public key cryptosystem.

The power analysis attacks include simple power analysis (SPA) and differential power analysis (DPA). The SPA guesses the secret key from the characteristic of a single power dissipation curve taken from the encryption processor. The DPA guesses the secret key by analyzes the differences between many different power dissipation curves (hereinafter referred to as the power difference curves). Generally, the DPA is more powerful than SPA.

The requirements of protection against the power analysis attack are described in the different international standards. For example, in the protection profile (PP) for the smart card in accordance with the International Standard ISO 15408 related to the security, protection is mandatory for countermeasure against the power analysis attack. On the other hand, in the U.S. Standard FIPS 140-2 related to encryption modules, only there is currently a comment only on the need for protection for countermeasure against the power analysis attack. However, protection for countermeasure against the power analysis attack will become mandatory in the future.

Different countermeasures have been developed for preventing the power analysis attacks SPA and DPA on the RSA and the elliptic curve encryption. However, a refined power analysis (RPA) attack has been released in L. Goubin, “A Refined Power-Analysis Attack on Elliptic Curve Crypto-systems”, PKC 2003, LNCS 2567, Springer-Verlag, 2003. This attack is effective to attacking a part of ciphertext in the public key cryptosystem which prevents the power analysis attack on elliptic curve encryption.

Next, technical terms used in elliptic curve encryption are described below. See the Standard IEEE P1363/D13 (Draft Version 13, Nov. 12, 1999) main document, Standard Specifications for Public Key Cryptography, http://grouper.ieee.org/groups/1363/P1363/draft.html for details.

A curve expressed by a function of variables x and y like the following is called an elliptic curve. An elliptic curve (over a prime field): y²=x³+ax+b (mod p),

where p is a prime number, and a and b are elliptic parameters (0≦a, b≦p).

An elliptic curve (over a binary field): y²+xy=x³+ax²+b (mod f(x))),

where f represents a polynomial of GF(2^{m}), and a and b are elliptic parameters (a, b ⊂ GF (2^{m})).

An elliptic curve are mainly defined over a prime field and a binary field. An elliptic curve is determined uniquely by the elliptic parameters a and b.

A point (elliptic point) on an elliptic curve has coordinates (x, y) that satisfy the formula expressing the elliptic curve. The elliptic points represent a set of integers (x, y) that satisfy 0≦x, y<p over a prime field, and represent a set of elements (x, y) that satisfy (x, y) ⊂ GF (2^{m}) over a binary field.

An infinite elliptic point denoted by O is a special point on an elliptic curve that satisfies A+O=O+A=A for an arbitrary elliptic point A, where the symbol “+” indicates addition of elliptic points.

A base elliptic point is a point on an elliptic curve, and denoted by G. The base elliptic point is shared by the users of elliptic curve encryption, and used for generating a pair of a public key and a private key and for other processing based on the elliptic curve encryption.

A representation of an elliptic point with a two-dimensional vector (x, y) is called affine coordinates. A representation of an elliptic point with a three-dimensional vector (X, Y, Z) that satisfies (x, y)=(X/Z, Y/Z) is called projective coordinates. A representation of an elliptic point with a three-dimensional vector (X, Y, Z) that satisfies (x, y)=(X/Z², Y/Z³) is called Jacobian coordinates. The use of three-dimensional vector representations significantly reduces the number of times of division in the elliptic point scalar multiplication to thereby speed up the entire computation.

An operation of A+B on elliptic points A and B is called an elliptic point addition, where the points satisfies A+B=B+A. An operation of A−B on elliptic points A and B is called an elliptic point subtraction.

An operation of elliptic point doubling derives a point C defined as C=2A on an elliptic curve, from a point A on the elliptic curve. This operation of 2A is called elliptic point doubling.

An operation of elliptic point scalar multiplication derives a point V defined as V=dA on an elliptic curve, from a point A on the elliptic curve and a scalar value d. This operation consists of a combination of the elliptic point addition, the elliptic point subtraction, and the elliptic point doubling.

For a base elliptic point G and a scalar value d representing a private key, a public key is given by V that satisfies V=dG. The public key is a point on the elliptic curve, and the private key is a scalar value.

Next, the power analysis attack is described below.

Algorithms for implementing the modular exponentiation or the elliptic point scalar multiplication include a binary method, a signed binary method, and a window method. It is assumed that the attacker knows the algorithm of modular exponentiation or elliptic point scalar multiplication implemented in the smart card.

FIG. 2 shows an algorithm of modular exponentiation in accordance with the conventional binary method. For given base a, exponent d and modulo n, a value of the modular exponentiation v=a^{d} (mod n) is determined. FIG. 3 shows an algorithm of elliptic point scalar multiplication in accordance with the conventional binary method. For given elliptic point A and scalar value d, an elliptic point V=dA representative of the scalar multiplication of the elliptic point is determined, where d is a binary value of m bits. The i-th bit value of the binary value d is denoted by d[i] (i=0, 1, . . . , m⁻¹). The value of a string from the i-th bit to the j-th bit (i≧j≧0) of the binary value d is expressed by d[i, j]. For example, for d=19=(10011)₂, d[4]=1, d[3]=0, d[2]=0, d[1]=1, and d[0]=1, and further d[0, 0]=(1)₂=1, d[1, 0]=(11)₂=3, d[2, 0]=(011)₂=3, d[3, 0]=(0011)₂=3, d[4, 0]=(10011)₂=19, and d[4, 1]=(1001)₂=9. ECADD represents the elliptic point addition, and ECDBL represents the elliptic point doubling.

Referring to FIG. 2, at Step 102, work variables t and v are initialized as t=a and v=1, respectively. Steps 103-106 form a loop for i. In this loop, the squaring at Step 105 for d[i]=0, and then both of the multiplication at Step 104 and the squaring at Step 105 for d[i]=1 are performed successively for i=0, 1, . . . , m−1. After Step 106, the value of the work variable v is expressed by v=a^{d[i, 0]} (mod n).

Referring to FIG. 3, at Step 202, work variables T and V are initialized as T=A and V=O, respectively. Steps 203-206 form a loop for i. In this loop, the doubling is for d[i]=0 at Step 205, and both of the elliptic point addition (ECADD) at Step 204 and doubling (ECDBL) at Step 205 for d[i]=1 are performed successively for i=0, 1, . . . , m−1. After Step 206, the value of the work variable V is expressed by V=d[i, 0].

The following correlations (COR.1) and (COR.2) hold between the algorithm and the private key d of FIG. 2 or 3.

(COR.1) There is correlation between the bit values of the value d and the operations performed. In the algorithm of FIG. 3, the ECDBL solely or both of the ECDBL and ECADD are performed in accordance with the bit values of d.

(COR.2) There is correlation between the bit values of the value d and the values of the work variable. In the algorithm of FIG. 3, the value of V after Step 106 is expressed by V=(d[i, 0])A=(2ⁱd[i])A+(d[i−1, 0])A.

The SPA determines the private key in accordance with the correlation (COR.1) above. The DPA guesses the private key in accordance with the correlation (COR.2). The RPA guesses the private key in accordance with any one of the correlations (COR.1) and (COR.2).

The SPA measures a single power waveform, and then guesses the processing performed in the smart card, to thereby guess the private key.

For example, it is assumed that the power consumption of a smart card that processes the algorithm of FIG. 3 is measured so that the power waveform illustrated in FIG. 4 is obtained. As shown in FIG. 4, if the obtained power consumption waveforms A and D have distinct shapes permitting the identification of the ECADD and ECDBL, then in accordance with correlation (COR.1), a group consisting of a power waveform D and a subsequent power waveform A corresponds to a bit value of one (1), while a special or distinctive waveform D corresponds to a bit value of zero (0). In this manner, a bit sequence “00110” for the private key is obtained.

Known countermeasures against the SPA include the Add-and-Double-Always and the Montgomery-Ladder, in which fixed computing procedure is repeated independently of the bit values of the private key d.

The Add-and-Double-Always is described in J. Coron, “Resistance against differential power analysis for elliptic curve cryptographic cryptosystem”, CHES '99, LNCS 1717, pp. 292-302, Springer-Verlag, 1999.

The Montgomery-Ladder is described in P. Montgomery, “Speeding the Pollard and elliptic curve methods for factorizations”, Math of Comp, vol. 48, pp. 243-264, 1987.

FIG. 5 shows an algorithm of the conventional Add-and-Double-Always. In this case, the computing procedure is a sequence of the ECADD, ECDBL, ECADD, ECDBL, . . . , ECADD, ECDBL, independently of the bit values of the private key d.

The DPA measures and analyzes a plurality of power waveforms, and thereby guesses the private key. The following procedure (DPA.01) through (DPA.03) gives an example of the DPA against the algorithm of FIG. 3. (DPA.01) For k elliptic points A₀, A₁, A₂, . . . , Aₖ₋₁ given at random, power consumption is measured for the duration of performing each multiplication of Aⱼ by d. The set of the k pieces of power consumption data measured during the scalar multiplication on Aⱼ is denoted by C(Aⱼ, t) (j=0, 1, . . . , k−1).

(DPA.02) The value of d[0] is guessed in accordance with the following procedure, and then the correctness of the guess is determined.

The guess value d[0] is assumed to be correct. Based on this assumption, the data value of the coordinates x of the variable V inside the smart card at the time when Steps 203-206 have been completed for i=0 is guessed for each Aⱼ. For example, if it is assumed that d[0]=1, then V=Aⱼ is guessed in accordance with the algorithm of FIG. 3. As a result of the guess, if the least significant bit of the data value of V is 1, then C(Aⱼ, t) is classified into G₁. In contrast, if the least significant bit of the data value of V is 0, then C(Aⱼ, t) is classified into G₀. The data value of V used in the classification may be the data value of y or z instead of x.

In accordance with the above-mentioned classification, a power difference curve is generated that is expressed as follows:
Δ(t)={average of C(Aᵢ,t)'sεG₁}−{average of C(Aᵢ,t)'sεG₀}.

When the power difference curve has a spike as shown in FIG. 6A, the guess value of d[0] is determined to be correct. In contrast, when the power difference curve is flat as shown in FIG. 6B, the guess value of d[0] is determined to be incorrect.

(DPA.03) Procedure (DPA.02) is repeated sequentially for d[1], d[2], . . . , d[m−1], so that the value of the private key d is determined. For performing procedure (DPA.02) for d[h], the data of V used as the criteria of the classification in procedure (DPA.02) is the data previously determined at the time of the procedure for i=h. In the guess of the data value of V, the previously determined values d[0] through d[h−1] and the current guess value of d[h] are used. This is so because the value of V is such a value determined by V=2^{h}d[h]A+d[h−1,0]A, i.e., the previously obtained d[0] through d[h−1] and the current guess value d[h].

The DPA is based on the characteristics that the power consumption of the smart card is proportional to the number of one's (1's) in the data value.

A known typical countermeasure against the DPA uses a random value. In this method, variable data is concealed or randomized using a random value generated inside the smart card, so that the guess for the data values by the DPA is prevented.

For example, in a so-called randomized projective coordinate system, the data representation of an elliptic point in projective coordinates or Jacobian coordinates is randomized. In this case, in the conventional encryption processing, for a work variable (x, y) expressed in the affine coordinates, this work variable is transformed into the projective coordinates (r×x, r×y, r×z) or into the Jacobian coordinates (r²×x, r³×y, r×z), where r indicates a random value. This random value r randomizes all of the coordinate data. Thus, the guess of the value of the work variable becomes impossible, so that the DPA is prevented. Although the value of the work variable is thus randomized, the value of any one of the work variables specifies the same point independently of the random value r. Thus, after determining d[0] through d[m−1], the determined coordinates are inversely transformed into affine coordinates, to thereby determine the same operated result dAⱼ uniquely as that of the conventional operation.

Next, the RPA is described below. The RPA guesses the bit value of the private key d, then selects a specific input elliptic point in accordance with the bit value, and then provides it as an input of the scalar multiplication of the encryption device, to thereby guess the private key d. When the work variable value at a specific timing of the scalar multiplication is zero (0), the guess of the bit value is determined to be correct in the RPA. Otherwise, the guess is determined to be incorrect. Whether the work variable value is zero can be determined using a single power waveform in the SPA or using the difference of a plurality of power waveforms in the DPA.

The following procedure of (RPA.01) through (RPA.03) gives an example of the RPA against the algorithm of FIG. 3. In the RPA, the attacker determines the next bit value d[h] in accordance with previously obtained d[0], d[1], . . . , d[h−1].

(RPA.01) A=(d[h, 0]⁻¹ (mod φ))Q is determined in accordance with the known values d[0], d[1], . . . , d[h−1] and the guess value d[h], where φ denotes the value of the order, and Q denotes a point on an elliptic curve satisfying Q=(x, 0) or (0, y), i.e., a set of coordinates which has the coordinate x or y equal to zero.

(RPA.02) The smart card is caused to perform the operation of dA, to thereby determine a power consumption wave form C(A, d).

(RPA.03) In the curve of the power consumption waveform C(A, d), a partial waveform corresponding to i=h and h+1 at Steps 203-206 is observed, and then it is determined whether the coordinate x of the work variable V is zero. See the document Goubin described above for the way of determining whether the coordinate x of V is zero.

The RPA is possible, because when the guess of d[h] is correct, the coordinate x or y of the work variable V becomes zero after the loop of Steps 203-206 is completed for i=h. For the coordinate x or y of V which becomes zero, an exceptional operation occurs when this value is used in the arithmetic operation for i=h+1. Then, the exceptional operation is observed in the power waveform.

FIGS. 7A and 7B illustrate power waveforms in the RPA.

When the guess of d[h] is correct, a waveform indicating the coordinate value of V appears after the loop for i=h. This is so because A is given in accordance with procedure (RPA.01). By giving such A, the value of V after the loop of Steps 203-206 for i=h becomes equal to Q, if the guess of d[h] is correct. Thus, the value of the coordinate x or y becomes zero (0).

Accordingly, the RPA can be prevented, by preparing an algorithm so as to prevent the coordinate value of the work variable from becoming zero (0) at the timing anticipated by the attacker.

The RPA is prevented basically by a countermeasure against the DPA that randomizes the data. However, there is an exception. For example, the randomized projective coordinate system which is one of the countermeasures against the DPA is vulnerable to the RPA. This is so because, when the work data in a process without a countermeasure against the DPA is denoted by (X, Y, Z), the work data is expressed by (r×X, r×Y, r×Z) in the randomized projective coordinate system. Thus, when the coordinate value in the process without a countermeasure against the DPA is zero (0), the coordinate value in the randomized projective coordinate system also becomes zero (0) independently of the value of r.

Izu et al. “Comparison and Evaluation of Side Channel Attack Countermeasure for Elliptic Cryptosystem” 2003, Symposium on Cryptography and Information Security (SCI 2003), 8D-3 released by the inventors describes that the most secure countermeasures against the power analysis attack to the public key cryptosystem corresponding to the elliptic cryptosystem are the four countermeasures, Randomized Projective Coordinates (RPC), Randomized Curve (RC), Exponent Splitting (ES), and Point Blinding (PB) against the SPA and the DPA. These are countermeasures against the DPA, but can be used together with the countermeasure against the SPA, to thereby prevent both of the DPA and the SPA.

Table 1 shows the comparison of security of the public key cryptosystem used together with the Add-and-Double-Always, against the SPA, the DPA and the RPA, and of the amount of processing required for the elliptic point scalar multiplication.

TABLE 1
SECURITY OF PUBLIC KEY CRYPTOSYSTEM AND
OF ELIPTIC SCALAR POINT MULTIPLICATION

| | | | | PROCESSING |
|---|---|---|---|---|
| | RPA | SPA | DPA | TIME |
| RPC | V | S | S | E + I |
| RC | V | S | S | E + I |
| ES | S | S | S | 2E + A |
| PB | S | S | S | 2E + 3A |

In TABLE 1, S indicates that the system is secure against the power analysis attack, and V indicates that the system is vulnerable to the power analysis attack. E denotes the processing time of the elliptic point scalar multiplication in the Add-and-Double-Always of FIG. 5, and A denotes the amount of processing of the elliptic point addition, subtraction and doubling, and I denotes the amount of processing for determining the inverse elements. Generally, E is much bigger than I and A.

The RPC and the RC achieve high-speed processing, but vulnerable to the RPA. The ES and the PB are secure against the RPA, but are slow.

FIG. 8A shows an algorithm of the RPC in the projective coordinate system. FIG. 8B shows an algorithm of the RPC in the Jacobian coordinate system. FIG. 8C shows an algorithm of the RC in the affine coordinate system.

Each of these algorithms includes the following three stages: (i) randomizing the coordinate data of an input elliptic point A (Steps 401-402 of FIG. 8A, Steps 501-502 of FIG. 8B, and Steps 601-602 of FIG. 8C); (ii) performing scalar multiplication using the Add-and-Double-Always (Steps 403-408 of FIG. 8A, Steps 503-508 of FIG. 8B, and Steps 603-608 of FIG. 8C); and (iii) de-randomizing the operated data and then providing the operation result as an output (Steps 409-410 of FIG. 8A, Steps 509-510 of FIG. 8B, and Steps 609-610 of FIG. 8C).

Stage (i) is a process for countermeasure against the DPA. A random value r is generated. Then, the coordinate data is randomized in accordance with A′=(r×A_{X}, r×A_{Y}, r×A_{Z}) in FIG. 8A, A′=(r²×A_{X}, r³×A_{Y}, r×A_{Z}) in FIG. 8B, and A′=(r²×A_{X}, r³×A_{Y}) in FIG. 8C, to thereby prevent the attacker from guessing the data, where A_{X}, A_{Y} and A_{Z} denote the coordinates (X, Y, Z) of the elliptic point A, respectively.

Stage (iii) is a process of de-randomizing the data to provide as an output the processed value which is the same as that of conventional encryption processing. The operation of V=(V[0]_{X}/V[0]_{Z}, V[0]_{Y}/V[0]_{Z}) is performed in FIG. 8A, the operation of V=(V[0]_{X}/(V[0]_{Z}))₂, V[0]_{Y}/(V[0]_{Z})³) is performed in FIG. 8B, and the operation of V=(V[0]_{X}/r², V[0]_{Y}/r³) is performed in FIG. 8C.

However, these countermeasures have no effect on the RPA. This is so because the product of the coordinate values and the random value r is introduced in the randomization at stage (i). For example, in FIG. 8C, when the work variable data without randomization is denoted by V=(V_{X}, V_{Y}), the work variable data at Steps 603-608 of stage (i) is expressed by V′=(r²×V_{X}, r³×V_{Y}). Thus, when either one of the values of the coordinates X and Y of V without randomization is zero (0), the either one of the values of the randomized coordinates X and Y of V′ becomes zero independently of the random value r, which satisfies the condition that permits the application of the RPA. Similarly, the RPC shown in FIGS. 8A and 8B does not provide protection against the RPA.

The RPC and the RC requires one time of the Add-and-Double-Always operation and one time of the inverse element operation for the de-randomization, for a total processing time of E+I.

FIG. 9A shows an algorithm of the ES, and FIG. 9B shows an algorithm of the PB.

Similarly to the algorithms of FIGS. 8A-8C, each of these algorithms includes the following three stages: (i) randomizing the coordinate data of an input elliptic point A (Steps 701-702 of FIG. 9A and Steps 801-802 of FIG. 9B); (ii) performing the scalar multiplication using the Add-and-Double-Always (Steps 703-704 of FIG. 9A and Steps 803-804 of FIG. 9B); and (iii) de-randomizing the operated data and then providing the operation result as an output (Steps 705-706 of FIG. 9A and Steps 805-806 of FIG. 9B).

In FIG. 9A, at stage (i), random scalar values d₁ and d₂ that satisfy d=d₁+d₂ are generated for a scalar value d. At stage (ii), scalar multiplication expressed by V₁=d₁A and V₂=d₂A for d₁ and d₂ described above is performed in accordance with the Add-and-Double-Always operation of FIG. 5. The work variables are randomized by the scalar multiplication for the random d₁ and d₂, to thereby provide countermeasure against the DPA. Further, the stages (i) and (ii) prevent the coordinate values of the work variables from becoming zero at the timing anticipated by the attacker. This provides countermeasure against the RPA. At stage (iii), the operation of V=V₁+V₂=dA+(d−r)A=dA de-randomizes the data, and provides dA as an output.

In FIG. 9B, at stage (i), random elliptic points A₁ and A₂ that satisfy A=A₁+A₂ are generated for an input elliptic point A. At stage (ii), scalar multiplication expressed by V₁=dA₁ and V₂=dA₂ for the elliptic points A₁ and A₂ described above is performed in accordance with the Add-and-Double-Always operation of FIG. 5. The work variables are randomized by the scalar multiplication for the random elliptic points A₁ and A₂, to thereby provide countermeasure against the DPA. Further, the stages (i) and (ii) prevent the coordinate values of the work variables from becoming zero at the timing intended by the attacker. This provides countermeasure against the RPA. At stage (iii), the operation of V=V₁+V₂=d(A₁+A₂)=dA de-randomizes the data, and provides dA as an output.

The ES requires two times of the Add-and-Double-Always operation, and one time of the elliptic point addition operation for the de-randomization, for a total processing time of 2E+A. The PB requires two times of the Add-and-Double-Always operation, and three times of the elliptic point addition or subtraction operation for randomizing the data and for de-randomizing the data, for a total processing time of 2E+3A.

Therefore, the known processing for the public key cryptosystem that requires a small amount of processing of the elliptic point scalar multiplication is vulnerable to the RPC, while the other known processing for public key cryptosystem that is secure against the RPC requires a large amount of processing of the elliptic point scalar multiplication.

The inventors have recognized that there is a need for providing a processing method for public key cryptosystem that requires a small amount of processing of the scalar multiplication and that is also secure against the SPA, the DPA and the RPC.

An object of the invention is to provide processing of public key encryption that requires a small amount of processing of the scalar multiplication and that is also secure against the SPA, the DPA and the RPC.

### SUMMARY OF THE INVENTION

In accordance with an aspect of the present invention, an encryption device for performing elliptic encryption processing with a private key, includes: a randomizing unit for setting, into an initial elliptic point V₀, an elliptic point R on an elliptic curve that is generated in accordance with a random value; an operation unit for performing a first operation of summing the initial elliptic point V₀ and a scalar multiple of a particular input elliptic point A on the elliptic curve, V₁=V₀+dA, in accordance with a bit sequence of a particular scalar value d for the elliptic encryption processing; a de-randomizing unit for performing a second operation of subtracting the initial elliptic point V₀ from the sum V₁ determined by the first operation, V=V₁−V₀; and a unit for providing, as an output, the elliptic point V determined by the de-randomization unit.

In accordance with another aspect of the present invention, an encryption device for performing modular exponentiation encryption processing with a private key, includes: a randomizing unit for setting, into an initial value V₀, an integer r generated in accordance with a random value; an operation unit for performing a first operation of modular exponentiation V₁=V₀a^{d} (mod n)=r×a^{d} (mod n) for the initial value V₀ and a particular input value a in accordance with a bit sequence of a particular value d for the modular exponentiation encryption processing; a de-randomizing unit for performing a second operation of modular multiplication V=V₁×r⁻¹ (mod n) on the value V₁ determined by the second operation and an inverse element r⁻¹ (mod n) of r (mod n); and a unit for providing, as an output, the value V determined by the de-randomizing unit.

The invention also relates to a program for implementing the encryption device described above.

The invention relates to a method for implementing the encryption device described above.

According to the invention, processing of public key encryption can be provided such that it requires a small amount of processing of the scalar multiplication and that is also secure against the SPA, the DPA and the RPC.

Throughout the drawings, similar symbols and numerals indicate similar elements.

### BRIEF DESCRIPTION OF THE DRAWINGS

FIG. 1 shows an example of the configuration of encryption/decryption with a secret key in an encryption device such as a smart card;

FIG. 2 shows an algorithm of modular exponentiation in accordance with the conventional binary method;

FIG. 3 shows an algorithm of elliptic point scalar multiplication in accordance with the conventional binary method;

FIG. 4 shows a power waveform obtained by measuring power consumption of the smart card;

FIG. 5 shows an algorithm of the conventional Add-and-Double-Always;

FIG. 6A shows a power consumption curve relative to time, which has a spike;

FIG. 6B shows a flat consumption curve relative to time;

FIGS. 7A and 7B illustrate power waveforms in the RPA;

FIG. 8A shows an algorithm of the RPC in the projective coordinate system;

FIG. 8B shows an algorithm of the RPC in the Jacobian coordinate system;

FIG. 8C shows an algorithm of the RC in the affine coordinate system;

FIG. 9A shows an algorithm of the ES;

FIG. 9B shows an algorithm of the PB;

FIG. 10 shows a schematic configuration of an encryption device in accordance with the present invention;

FIG. 11 shows a basic algorithm for public key encryption processing provided with a countermeasure against the power analysis attack, in accordance with the invention, performed by the encryption device of FIG. 10;

FIG. 12 shows a basic algorithm performed by the encryption device of FIG. 10, in which a countermeasure against the power analysis attack in accordance with the invention is applied to the elliptic curve encryption;

FIG. 13 shows a basic algorithm provided with a countermeasure against the power analysis attack in accordance with the invention applied to the RSA encryption, performed by the encryption device of FIG. 10;

FIGS. 14 to 16 show respective different algorithms of generating the random elliptic point R in FIG. 12;

FIG. 17 shows an algorithm of generating an elliptic point R in the projective coordinate system shown in FIG. 12;

FIG. 18 shows an algorithm of generating an elliptic point R in the Jacobian coordinate system shown in FIG. 12;

FIG. 19 shows an embodiment of the elliptic point doubling performed on the work variable V[2] in FIG. 12; and

FIG. 20 shows an embodiment of the basic algorithm in accordance with the invention shown in FIG. 12, which is a combination of the algorithms of FIGS. 15, 16 and 19.

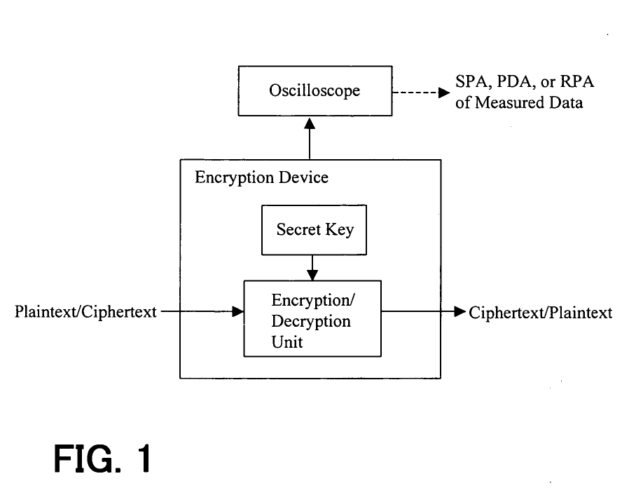

### DETAILED DESCRIPTION OF THE PREFERRED EMBODIMENTS

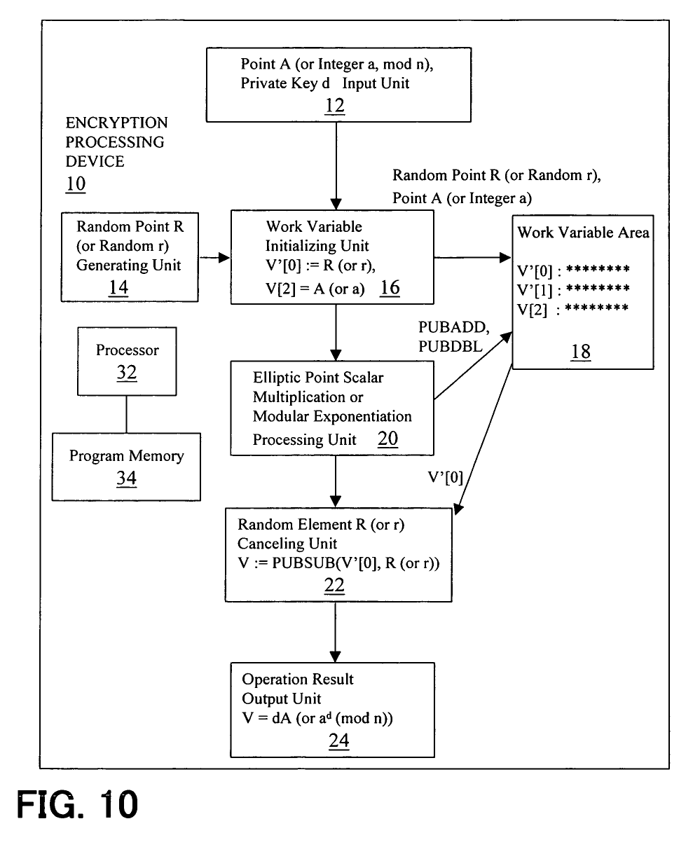

FIG. 10 shows a schematic configuration of an encryption device 10 in accordance with the present invention. The encryption device 10 includes: an input unit 12 for inputting and providing values a, d and n, or alternatively, values A and d; a random value or elliptic point generating unit 14 for generating a random value R or r; a work variable initializing unit 16 for initializing work variables such that V′[0]:=R (or r) and V[2]=A (or a), in accordance with the random value R or r received from the random value generating unit 14; and a memory 18 for storing the work variables V′[0], V′[1] and V[2]. The encryption device 10 further includes a scalar multiplication processing unit 20 for repeatedly performing the operations of Public Key Addition (PUBADD) and Public Key Doubling (PUBDBL) on the work variables of the initializing unit 16 with detecting the bit values of the value d, and thereby performing the operation of V[0]=dA+R or a^{d}×r (mod n), where the PUBADD denotes elliptic point addition or modular multiplication modulo n, and the PUBDBL denotes elliptic point doubling or modular squaring modulo n. The procedure of performing the PUBADD and PUBDBL operations does not depend on the bit values of d. The encryption device 10 further includes a random element canceling unit for performing the operation of V=PUBSUB(V′[0], R or r) on V′[0] to determine V=dA in which the influence of R or r has been cancelled, where the public key subtraction PUBSUB denotes elliptic point subtraction, or modular multiplication modulo n using the inverse element of r. The encryption device 10 further includes an output unit 24 for providing the value of the operation result V=dA or V=a^{d} (mod n) as an output, where R or r is a value generated inside the encryption device 10 and cannot be accessed from the outside.

The encryption device 10 further includes a processor 32 and a program memory 34 such as a ROM. The processor 32 controls the elements 12-24 described above in accordance with a program stored in the memory 34. Alternatively, the processor 32 may implement the elements 12-24 by executing a program stored in the memory 34 and corresponding to the functions of the elements 12-24. In this case, FIG. 10 serves as a flow diagram.

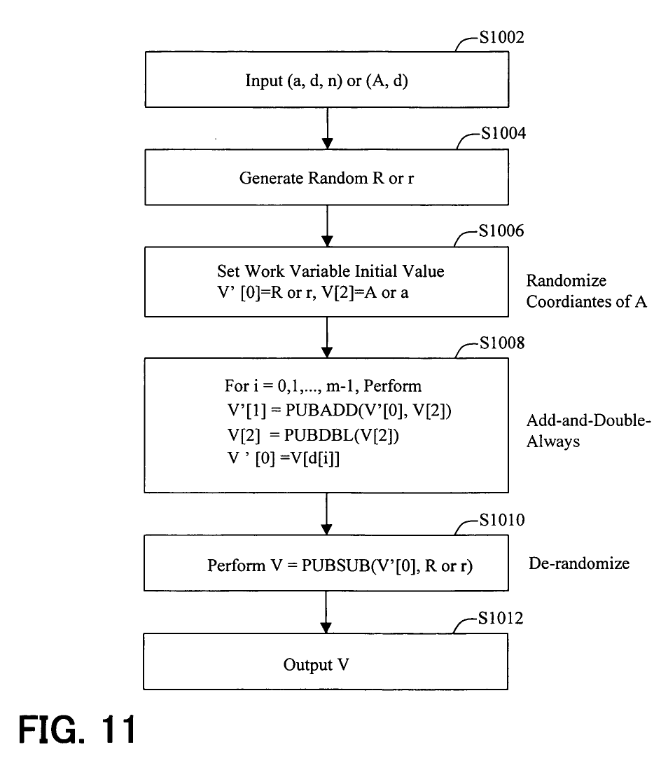

FIG. 11 shows a basic algorithm for public key encryption processing provided with a countermeasure against the power analysis attack, in accordance with the invention, performed by the encryption device 10 of FIG. 10. This algorithm is applicable to both of the elliptic curve encryption and the RSA encryption.

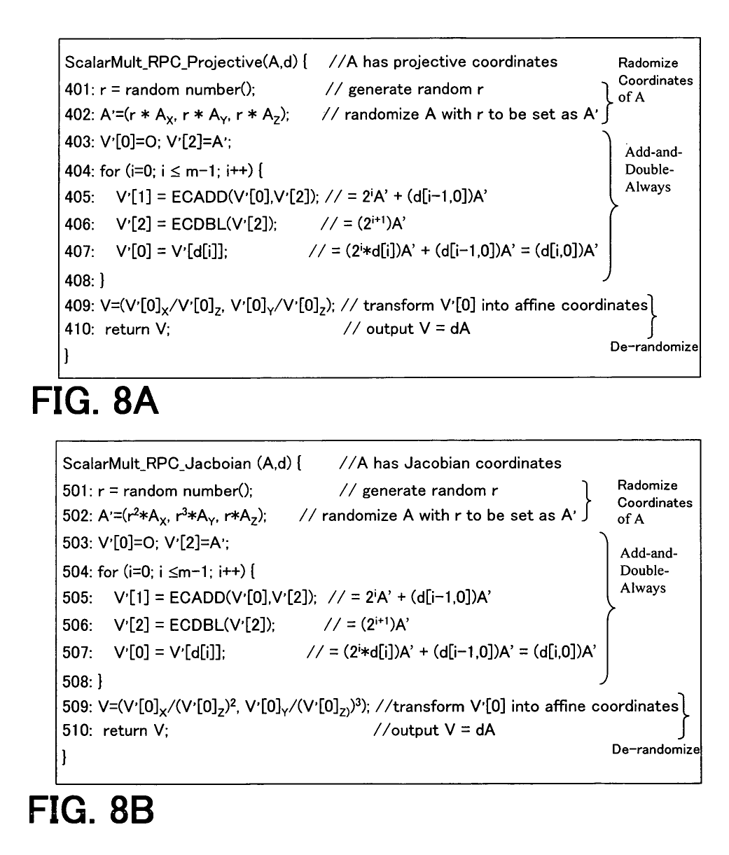

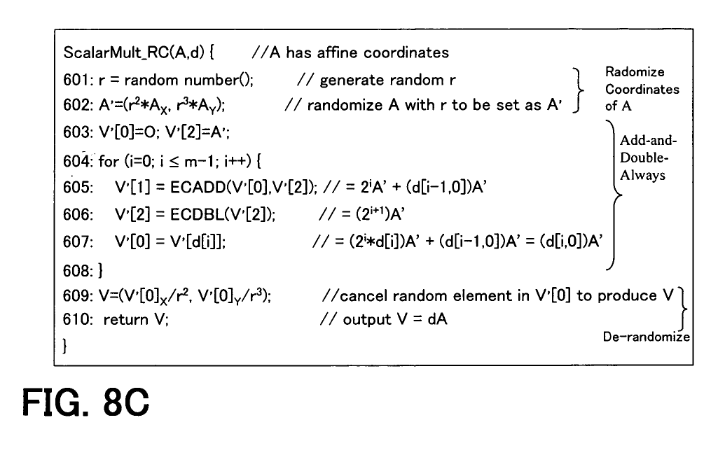

Similarly to the algorithms of FIGS. 8A-8C, the algorithm of FIG. 11 includes the following three stages: (i) randomizing the data (Steps 1004-1006); (ii) performing the scalar multiplication using the Add-and-Double-Always (Step 1008); and (iii) de-randomizing the operated data and then providing the operation result as an output (Step 1010).

Referring to FIG. 11, at Step 1002, the input unit 12 receives values a, d and n, or alternatively values A and d. At Step 1004, the random value generating unit 14 generates random data R or r, where R or r denotes the data of a random elliptic point on an elliptic curve in the elliptic curve encryption, or alternatively a random integer value in the RSA.

At Step 1006, the initializing unit 16 initializes the work variables to be used in the Add-and-Double-Always, such that V[0]=R or r, and V[2]=A or a.

At Step 1008, the scalar multiplication processing unit 20 for an elliptic point performs the Add-and-Double-Always with the work variable V′[0], V′[1] and V[2]. Thus, for i=0, 1, . . . , m−1, the operations of V′[1]=ECADD(V′[0], V[2]), V[2]=ECDBL(V[2]), and V′[0]=V′[d[i]] are repeatedly performed in the elliptic curve encryption, or alternatively the operations of V′[1]=V′[0]×V[2] (mod n), V[2]=V[2]² (mod n), and V[0]=V′[d[i]] are repeatedly performed in the RSA encryption. Independently of the bit values of the private key d, a predetermined operation pattern of the Add-and-Double-Always is repeated, to thereby provide protection against the SPA. By providing V′[0]=R or r at Step 1004, the values of the work variables V′[0] and V′[1] are randomized to thereby prevent the DPA. The value of V[2] is not randomized. This is so because the DPA and the SPA using the value of V[2] are impossible in the Add-and-Double-Always, so that the randomization of V[2] is not required. The value of V[2] can be determined by repeating the doubling or the squaring of the value A, independently of the bit values of the private key d. Thus, the DPA cannot be achieved using this value.

At Step 1010, the random element canceling unit 22 de-randomizes the randomized data. For this purpose, for R generated at Step 1004, the operation of V=V′[0]−R is performed in the elliptic curve encryption, whereas the operation of V=V′[0]×r⁻¹ is performed in the RSA. At Step 1012, the output unit 24 provides the operation result V as an output.

In this way, the SPA and the DPA are prevented by the algorithm of FIG. 11. The following describes that the RPA is prevented when the algorithm of FIG. 11 is applied to the elliptic curve encryption.

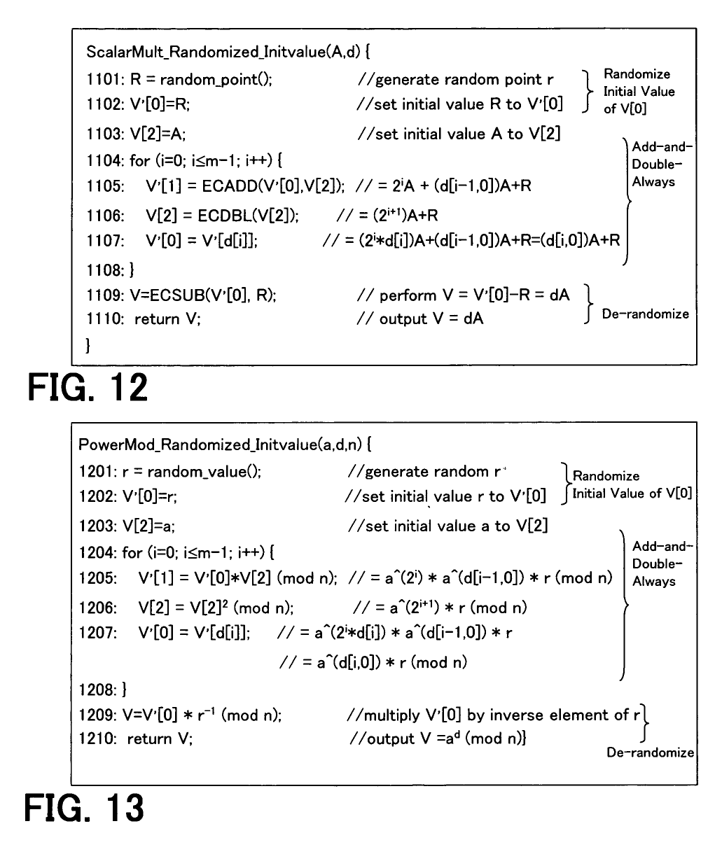

FIG. 12 shows a basic algorithm performed by the encryption device 10 of FIG. 10, in which a countermeasure against the power analysis attack in accordance with the invention is applied to the elliptic curve encryption.

Referring to FIG. 12, at Step 1101, the random value generating unit 14 generates or selects a random elliptic point R on an elliptic curve. The initializing unit 16 at Step 1102 sets R as the initial value into the work variable V′[0], and then at Step 1103 sets A as the initial value into the work variable V[2].

The loop including Steps 1104-1108 performs the elliptic point scalar multiplication through the Add-and-Double-Always for the work variables V′[0], V′[1] and V[2] Although this loop performs the same processing as the Add-and-Double-Always without a countermeasure against the RPA of Steps 303-307 of FIG. 5, the random elliptic point R is set as the initial value of V′[0], to thereby provide protection against the RPA.

With these initial values, the relations between the work variables V′[0] and V′[1] of FIG. 12, and the work variables V[0] and V[1] of FIG. 5, are expressed by V′[0]=V[0]+R and V′[1]=V[1]+R, respectively. Thus, in contrast to the values of V[0] and V[1] of the work variables determined in FIG. 5, the algorithm of FIG. 12 determines V′[0]=V[0]+R and V′[1]=V[1]+R, where these values of the work variables vary at random depending on R. Thus, in contrast to the RPC and the RC, the coordinate data of V′[0] and V′[1] is prevented from becoming zero (0) independently of the random value R. Thus, the attacker cannot intentionally set the coordinate data values of the work variables to be zero (0), so that the RPA is prevented.

Upon completion of the loop of Steps 1104-1108, the output unit 24 at Step 1109 performs the operation of V=V′[0]−R to thereby de-randomize the data which has been randomized with R, and then provides the value V as an output.

In this way, the algorithm in accordance with the invention provides the encryption processing which is secure against the RPA. The algorithm of FIG. 12 in accordance with the invention in comparison with the algorithm of FIG. 5 without a countermeasure against the RPA, includes the generation of the elliptic point R at Step 1101 and the subtraction of the elliptic point R at Step 1109 which are the only added processing for the countermeasure against the RPA. Thus, the speed reduction involved in the countermeasure against the RPA is limited to that caused by the processing of these two steps or operations. This provides high speed processing in comparison with the ES and the PB that require twice the processing time of the algorithm of FIG. 5.

FIG. 13 shows a basic algorithm provided with a countermeasure against the power analysis attack in accordance with the invention in application to the RSA encryption, performed by the encryption device 10 of FIG. 10.

Referring to FIG. 13, at Step 1201, the random value generating unit 14 generates a random value r. The initializing unit 16 at Step 1202 sets R as the initial value into the work variable V′[0], and at Step 1203 sets a as the initial value into the work variable V[2].

The loop including Steps 1204-1208 performs modular exponentiation through the Add-and-Double-Always for the work variables V′[0], V′[1] and V[2], to thereby update these work variables.

Upon completion of the loop of Steps 1204-1208, the output unit 24 at Step 1209 performs the modular multiplication of V′[0] by the inverse element r⁻¹ (mod n) of r, to thereby de-randomize the data which has been randomized with r, and then provides the result V as an output.

The loop including Steps 1204-1208 for the Add-and-Double-Always prevents the SPA. Further, the random value r set as the initial value to the work variable V′[0] causes the work variables in the loop to vary at random, which prevents the DPA.

In comparison with the algorithm of FIG. 5 applied to the RSA, the generation of r at Step 1201 and the modular multiplication by the inverse element of r at Step 1209 are the only added processing for the countermeasure against the RPA, as overhead for the processing.

Next, embodiments of the basic algorithm for elliptic curve encryption of FIG. 12 are described below.

There are a plurality of embodiments for generating the elliptic point R at Step 1101 of FIG. 12 and doubling V[2] at Step 1107. The embodiments have respective different required amounts of computation.

FIGS. 14 through 18 show respective different algorithms of generating the random elliptic point R at Step 1101 of FIG. 12.

Referring to FIG. 14, at Step 1301, the random value generating unit 14 generates a possible arbitrary value of the coordinate X at random, and then sets the value X into R_{X}. Thus, the elliptic curve encryption with the elliptic curve parameters over the prime field generates an integer satisfying 0≦R_{X}<p, whereas the elliptic curve encryption with the elliptic curve parameters over the binary field generates a random value of GF(2^{m}). At Step 1302, a coordinate Y corresponding to the given coordinate X is determined to thereby generate R_{Y}. At Steps 1303 and 1304, R=(R_{X}, R_{Y}) is set. The algorithm of deriving the coordinate Y from the coordinate X is described in the IEEE P1363/D13 described above.

Referring to FIG. 15, the generating unit 14 at Step 1401 generates a random value s, and at Step 1402 sets, into R, the sG derived by multiplying the base elliptic point G by s through the Add-and-Double-Always of FIG. 5. Alternatively, in place of the algorithm of FIG. 5, the algorithm of FIG. 12 may be performed for R=O, d=s and A=G. Such shared use of the same algorithm improves the efficiency of utilization of the resources. The random value s is an arbitrary value. However, if this value has the bit length exceeding that of the scalar value d, then the computation overhead in the scalar multiplication at Step 1402 becomes large. In the elliptic curve encryption of 160 bits as an example, if s is a random value of 160 bits, then the amount of computation at Step 1402 becomes large. As a result, the amount of computation of the entire algorithm in accordance with the invention becomes approximately twice of that of the algorithm of FIG. 5, so that the processing speed falls significantly. Thus, s is preferably a value of 20 to 30 bits.

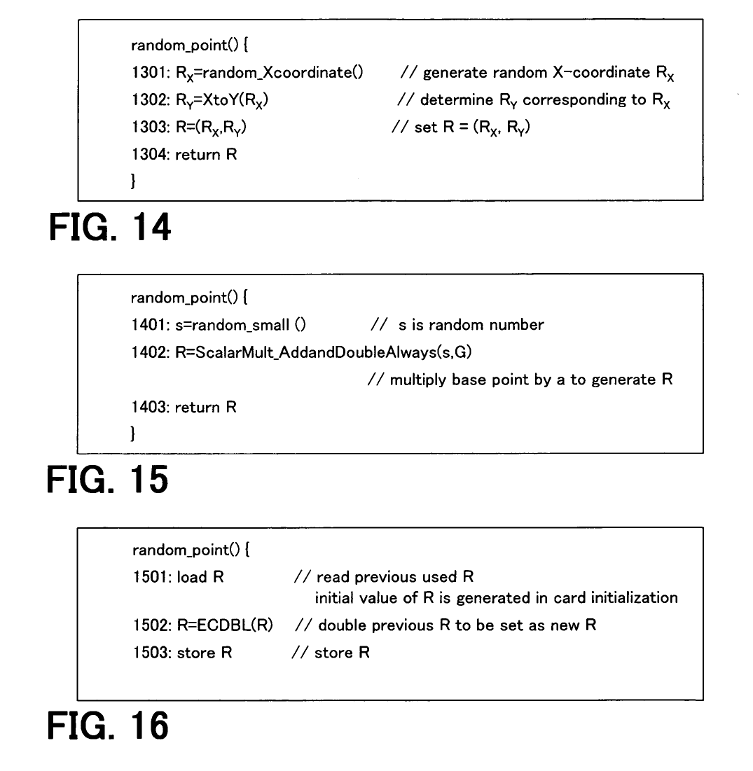

FIG. 16 shows an algorithm of updating or the value of the elliptic point R at each time of calling the encryption processing protected from the power analysis attack in accordance with the invention, which occurs after the initial value of an elliptic point R is given at random in the initialization or the like of a smart card. This updating is implemented in simple operation, whereby the processing time of this algorithm can be made shorter than that of the algorithms of FIGS. 14 and 15.

At Step 1501, the generating unit 14 reads a value of R used in the conventional countermeasure against the power analysis attack, from a specific area in the memory. Alternatively, the initial value of the elliptic point R may be provided in accordance with the method shown in FIGS. 14 and 15. At Step 1502, the generating unit 14 performs the doubling of the elliptic point R to thereby update the value of R. At Step 1503, the generating unit 14 stores the updated value of the elliptic point R for use in the next processing.

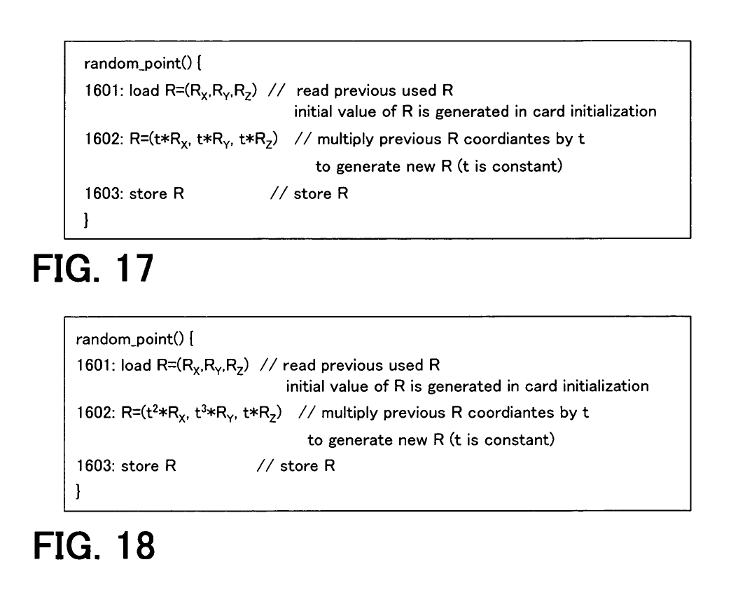

FIG. 17 shows an algorithm of generating an elliptic point R shown in FIG. 12 defined in the projective coordinate system. FIG. 18 shows an algorithm of generating an elliptic point R shown in FIG. 12 defined in the Jacobian coordinate system.

In these algorithms, similarly to the algorithm of FIG. 16, the generating unit 14 generates the initial value of the elliptic point R at random in the initialization or the like of the smart card. After that, the generating unit 14 updates the initial value of the elliptic point R at each time of calling the encryption program in accordance with the invention.

Similarly to the algorithm of FIG. 16, the generating unit 14 at Step 1601 reads the previous R stored in the memory 18, and at Step 1603 stores the updated R. In FIG. 17, the generating unit 14 at Step 1602 multiplies the coordinate value R=(R_{X}, R_{Y}, R_{Z}) by a constant t, to thereby update the initial or previous value R. In FIG. 18, the generating unit 14 at Step 1602 multiplies the coordinate component values of R=(R_{X}, R_{Y}, R_{Z}) by respective constants t, t² and t³, to thereby update the initial or previous value R. The value of t is selected to be a small value, such as t=3, to thereby reduce the amount of computation required for updating R.

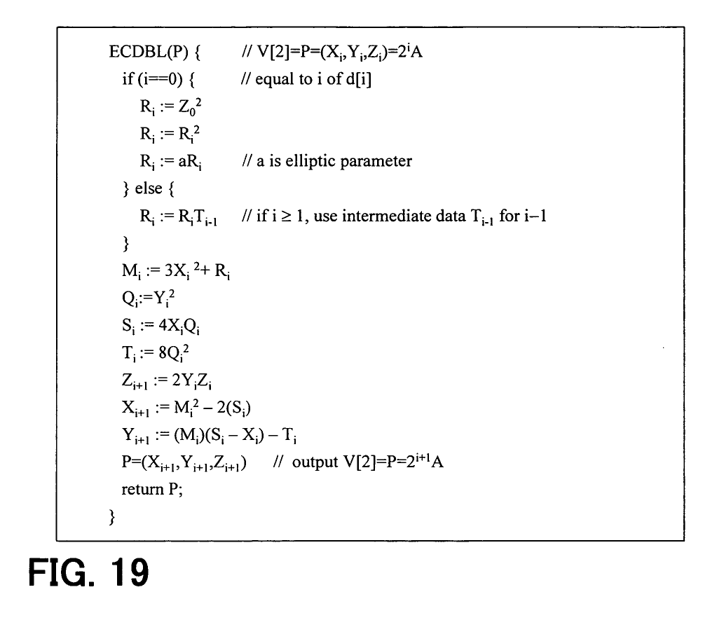

FIG. 19 shows an embodiment of the elliptic point doubling performed on the work variable V[2] at Step 1107 of FIG. 12.

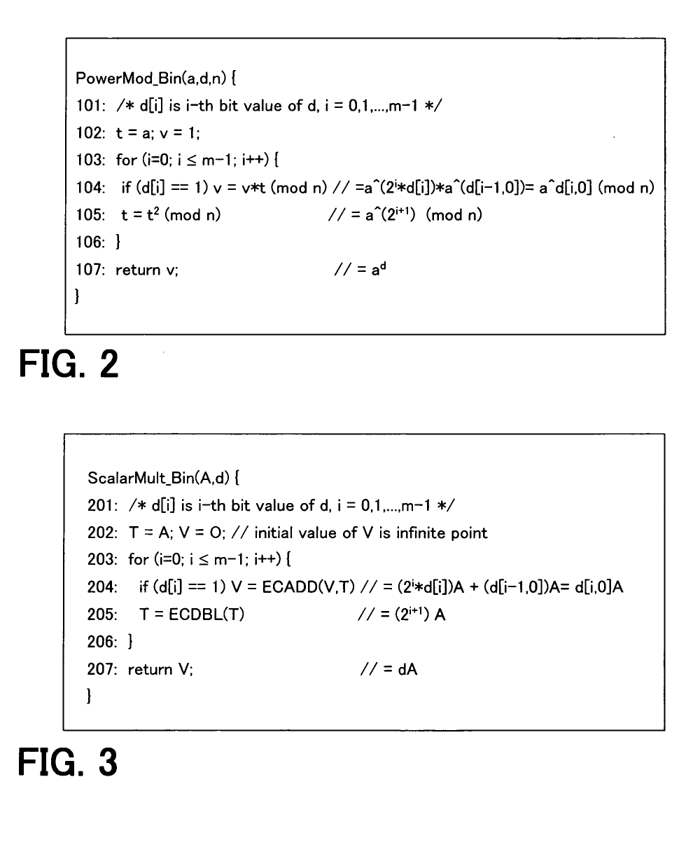

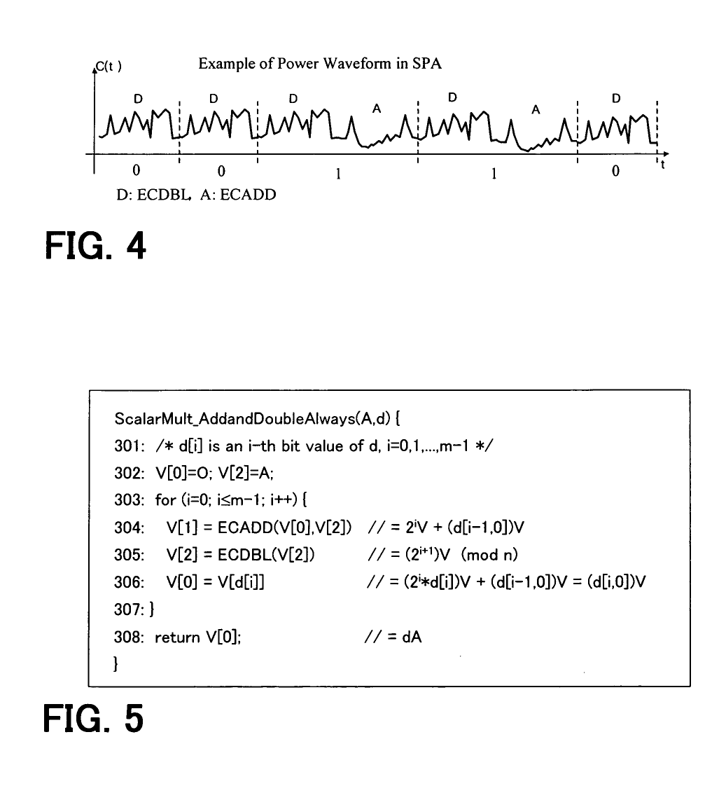

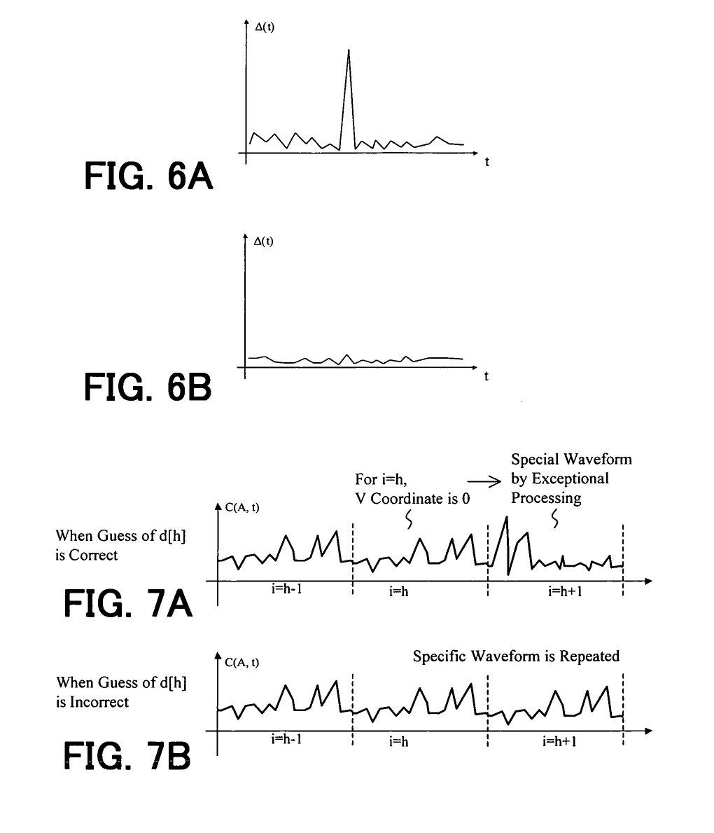

The elliptic point doubling at Step 1107 is repeatedly performed on the same work variable V[2]. The value of V[2] is expressed by V[2]=2ⁱ⁺¹A using the loop variable i. The technique of accelerating the computation by repeatedly performing the doubling on the same point (elliptic point 2^{k}-multiplication) in the Jacobian coordinate system and the prime field is disclosed in Japanese Patent Application Publication JP 2000-137436-A published on May, 16, 2000 and invented by Takenaka and Ito, two of the present inventors, the entirety of which is incorporated herein by reference. In FIG. 19, the technique of elliptic point 2^{k}-multiplication shown in FIG. 2 of the publication is employed.

The loop variable i in FIG. 19 has the same value as the loop variable i of FIG. 17. This algorithm represents the operation between the input of A[2]=(Xᵢ, Yᵢ, Zᵢ)=2ⁱA as a variable P and the output of A[2]=(Xᵢ₊₁, Yᵢ₊₁, Zᵢ₊₁)=2ⁱ⁺¹A. For i=0, the procedure branches away to a process for i=0 using an if-clause, so that the same processing as the conventional doubling in the Jacobian coordinate system over the prime field is performed. For i≧1, the procedure branches away to a process for i≧1 using an if-clause. For this purpose, in determining the work variable Rᵢ for the elliptic point doubling, the value of the work variable Tᵢ₋₁ for i−1 is reused, which reduces the amount of computation. When the standard elliptic point doubling described in the document IEEE P1363 described above is used, ten times of multiplication is required for each processing. However, when the algorithm of FIG. 19 is used, only eight times of multiplication is required for each processing. Thus, the algorithm of FIG. 19 reduces, by twenty percent, the amount of computation required for the elliptic point doubling in the standard method.

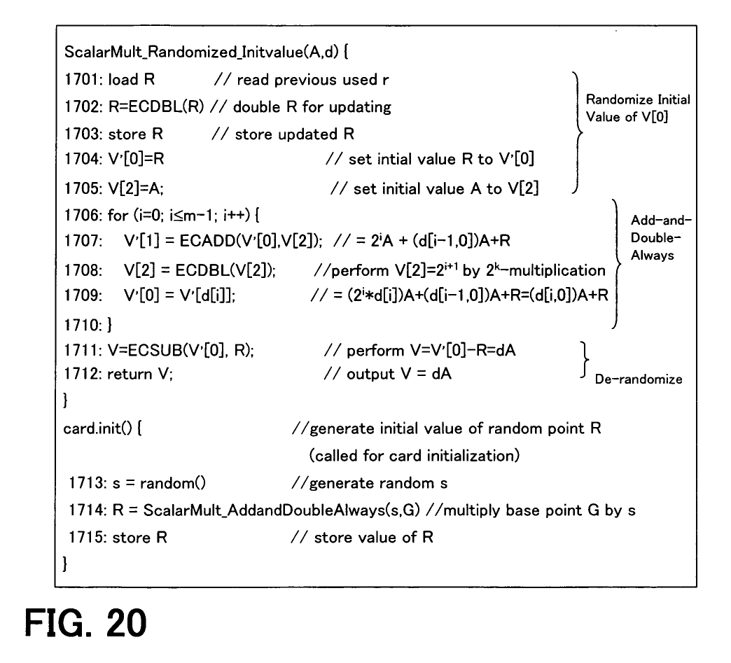

FIG. 20 shows an embodiment of the basic algorithm in accordance with the invention shown in FIG. 12, which is a combination of the algorithms of FIG. 15 (the initialization of R), FIG. 16 (the generation of R at Step 1101), and FIG. 19 (the elliptic point 2^{k}-multiplication at Step 1106).

Alternatively, Step 1101 of FIG. 12 may be replaced by any corresponding one of FIGS. 14-18, while Step 1106 may be replaced by any corresponding one of FIG. 19 and the above-mentioned document IEEE P1363, to thereby form a combination.

Next, an embodiment of the basic algorithm for the RSA encryption of FIG. 13 is described below. FIG. 18 per se serves as an embodiment for countermeasure against the power analysis attack to the RSA encryption. This is so because there is no modification of generating the random value r at Step 1201 and of squaring at Step 1206.

As described above, the embodiments of the invention provide countermeasures against all of the analyses of the SPA, the DPA and the RPA, and requires the smaller amount of computation than that of the ES and the PB which are known as generally secure systems.

Table 2 shows the comparison between the elliptic curve encryption in accordance with the invention and the conventional public key encryption for countermeasure against the power analysis attack. Table 3 shows the comparison between the RSA encryption in accordance with the invention and the conventional public key encryption for countermeasure against the power analysis attack. In Table 3, the RPC, RC and PB encryptions are not applicable to the elliptic curve encryption, and hence are not shown.

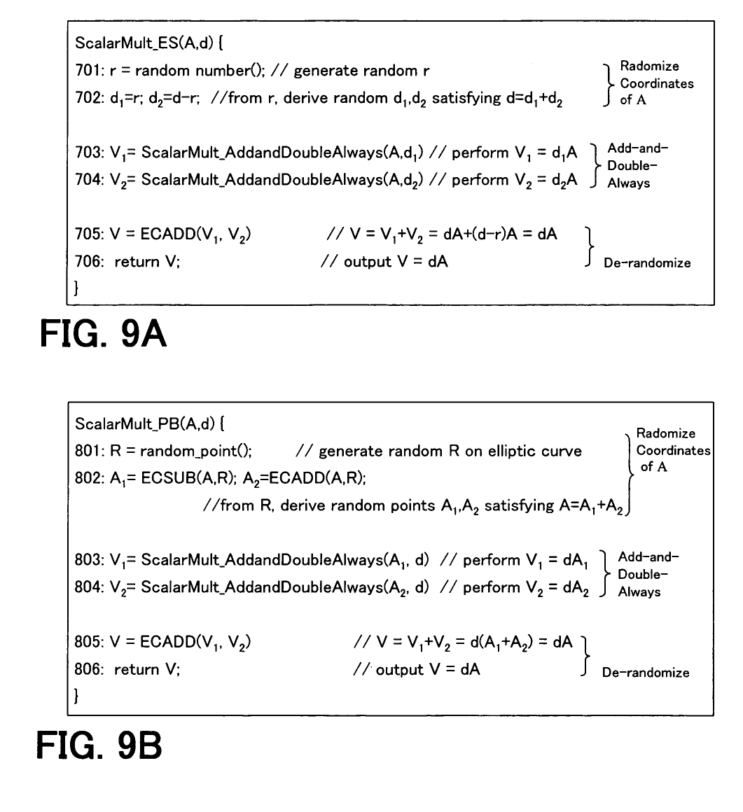

TABLE 2
COMPARISON OF COUNTERMEASURES AGAINST POWER
ANALYSIS ATTACK FOR ELLIPTIC ENCRYPTION

| | | | | Processing |
|---|---|---|---|---|
| | RPA | SPA | DPA | Time |
| RPC (FIGS. 8A & 8B) | V | S | S | E + I |
| RC (FIG. 8C) | V | S | S | E + I |
| ES (FIG. 9A) | S | S | S | 2E + 1A |
| PB (FIG. 9B) | S | S | S | 2E + 3A |
| Invention (FIG. 20) | S | S | S | E + 2A |

TABLE 3
COMPARISON OF COUNTERMEASURES AGAINST
POWER ANALYSIS ATTACK FOR RSA

| | | | Processing |
|---|---|---|---|
| | SPA | DPA | Time |
| ES (FIG. 9A) | S | S | 2E |
| Invention (FIG. 13) | S | S | E + I |

In Tables 2 and 3, “S” indicates that the system is secure against the analysis, and “V” indicates that the system is vulnerable to the analysis. “E” indicates the processing time of scalar multiplication in the Add-and-Double-Always without a countermeasure against the power analysis attack. “I” indicates the processing time of determining the inverse elements. “A” indicates the processing time of elliptic point addition, elliptic point subtraction, and elliptic point doubling. However, A is smaller than E and hence is negligible.

The amount of processing in the conventional encryption is shown in TABLE 1. In the algorithm of FIG. 20 in accordance with the invention, the same operation as the Add-and-Double-Always of FIG. 5 is performed, except for the elliptic point doubling at Step 1702 and the elliptic point subtraction at Step 1711. Thus, the total amount of processing is expressed by E+2A.

As can be seen from TABLE 2, the encryptions secure against all of the SPA, the DPA and the RPA are the ES encryption, the PB encryption and the encryption according to the invention. In comparison of the processing time, A is much smaller than E and negligible, and hence the processing time of the encryption of the invention is approximately half the processing time of the secure ES and PB encryptions.

A is much smaller than E and negligible, apparently because each of the elliptic point addition and doubling are performed m times in the Add-and-Double-Always, for a total of 2 m times. For example, for m=160 in the elliptic curve encryption of 160 bits, E=320A.

The amount of computation required for the ES is 2E, because the computing procedure of the ES in the RSA is as follows:
v₁=a^{d1}(mod n),
v₂=a^{d2}(mod n), and
v=v₁v₂(mod n)=a^{d}(mod n),
where the modular multiplication of v₁ and v₂ is assumed to be much smaller than the modular exponentiation and negligible. The processing of FIG. 13 in accordance with the invention is formed by the Add-and-Double-Always at Steps 1201-1208 and the operation of determining the inverse element r⁻¹ (mod n) at Steps 1209-1210, to thereby provide the amount of processing expressed by E+I in total. Thus, for E>I, the invention provides the processing at the higher speed than the ES. Although the relative magnitudes of E and I vary depending on the processing environment, generally E is proportional to the third power of the operation bit length, while I is proportional to the second power of the operation bit length. This verifies that the assumption of E>I is reasonable. Thus, the invention reduces the processing time without degrading the security against the power analysis attack.

The above-described embodiments are only typical examples, and their modifications and variations are apparent to those skilled in the art. It should be noted that those skilled in the art can make various modifications to the above-described embodiments without departing from the principle of the invention and the accompanying claims.

What is claimed is:

1. An encryption device for performing elliptic encryption processing with a private key, comprising:
a randomizing unit for setting, into an initial elliptic point V₀, an elliptic point R on an elliptic curve that is generated in accordance with a random value;
an operation unit for performing a first operation of summing the initial elliptic point V₀ and a scalar multiple of a particular input elliptic point A on the elliptic curve, V₁=V₀+dA, in accordance with a bit sequence of a particular scalar value d for said elliptic encryption processing;
a de-randomizing unit for performing a second operation of subtracting the initial elliptic point V₀ from the sum V₁ determined by said first operation, V=V₁−V₀; and
a unit for providing, as an output, the elliptic point V determined by said de-randomization unit.

2. An encryption device according to claim 1, wherein said operation unit repeatedly performs the operations of:
elliptic point addition V[1]:=V[0]+V[2],
elliptic point doubling V[2]:=2V[2], and
substitution V[0]:=V[d[i]],
where V[2] indicates another variable, the input elliptic point A is set as an initial value of the variable V[2], the scalar value d is an m-bit sequence, and d[i] denotes a value of the i-th LSB of the scalar value d for i=0, 1, . . . , m−1.

3. An encryption device according to claim 1, wherein said randomizing unit generates a coordinate X of the elliptic point R on the elliptic curve, then generates a coordinate Y of the elliptic point R in accordance with the coordinate X, and then sets, as the initial elliptic point V₀, the generated coordinates (X, Y) expressing the elliptic point R.

4. An encryption device according to claim 1, wherein said randomizing unit generates a random value s, then determines a base elliptic point G multiplied by s, and then sets the determined sG as the elliptic point R into the initial elliptic point V₀.

5. An encryption device according to claim 4, wherein for the determination of the sG, said randomizing unit sets the infinite elliptic point O as an initial value into the work variable V[0], then sets the G as an initial value into the work variable V[2], and then repeatedly performs the operations of:
elliptic point addition V[1]:=V[0]+V[2],
elliptic point doubling V[2]:=2V[2], and
substitution V[0]:=V[d[i]],
where the scalar value d is an m-bit sequence, and d[i] denotes a value of the i-th LSB of the scalar value d for i=0, 1, . . . , m−1.

6. An encryption device according to claim 4, wherein for the determination of the sG, said randomizing unit sets a random value s as the scalar value d, then sets the input elliptic point A as the base elliptic point G, and then sets the infinite elliptic point O as the elliptic point R, so as to determine sG=O+sG based on said first operation of V₁=V₀+dA.

7. An encryption device according to claim 1, wherein an elliptic point R₀ on the elliptic curve generated at first at random is set as the elliptic point R, and thereafter an elliptic point Rₙ on the elliptic curve expressed by a function Rₙ=f(Rₙ₋₁, c) is used as the elliptic point R, where Rₙ denotes the n-th time of the elliptic encryption processing, and c indicates a constant.

8. An encryption device according to claim 7, wherein when a previous elliptic point Rₙ₋₁ on the elliptic curve is expressed by an elliptic point (R_{X}, R_{Y}, R_{Z}) in projective coordinates, a current elliptic point Rₙ on the elliptic curve is expressed by an elliptic point (c×R_{X}, c×R_{Y}, c×R_{Z}) in the projective coordinates.

9. An encryption device according to claim 7, wherein when a previous elliptic point Rₙ₋₁ on the elliptic curve is expressed by an elliptic point (R_{X}, R_{Y}, R_{Z}) in Jacobian coordinates, a present elliptic point Rₙ on the elliptic curve is expressed by an elliptic point (c²×R_{X}, c³×R_{Y}, c×R_{Z}) in the Jacobian coordinates.

10. An encryption device according to claim 2, wherein said elliptic encryption processing is the operation using Jacobian coordinates for elliptic curve parameters over a prime field, where P=V[2]=(Xᵢ, Yᵢ, Zᵢ)=2ⁱA, wherein
for i=0, Rᵢ is determined by sequentially performing the operations of Rᵢ:=Z₀², Rᵢ:=Rᵢ², and Rᵢ:=aRᵢ;
for i≧1, Rᵢ is determined by performing the operation of Rᵢ:=RᵢTᵢ₋₁, where Tᵢ₋₁ denotes intermediate data for i−1; and
P=(Xᵢ₊₁, Yᵢ₊₁, Zᵢ₊₁)=2ⁱ⁺¹A is determined by performing, in accordance with the determined Ri, the operations of Mᵢ:=3Xᵢ+Rᵢ, Qᵢ:=Yᵢ², Sᵢ:=4XᵢQᵢ, Tᵢ:=8Qᵢ², Zᵢ₊₁:=2YᵢZᵢ, Xᵢ₊₁:=Mᵢ²−2Sᵢ, and Yᵢ₊₁:=Mᵢ (Sᵢ−Xᵢ)−Tᵢ, in this order or in a different order, and then is outputted as V[2].

11. An encryption device for performing modular exponentiation encryption processing with a private key, comprising:
a randomizing unit for setting, into an initial value V₀, an integer r generated in accordance with a random value;
an operation unit for performing a first operation of modular exponentiation V₁=V₀a^{d} (mod n)=r×a^{d} (mod n) for the initial value V₀ and a particular input value a in accordance with a bit sequence of a particular value d for said modular exponentiation encryption processing;
a de-randomizing unit for performing a second operation of modular multiplication V=V₁×r⁻¹ (mod n) on the value V₁ determined by said first operation and an inverse element r⁻¹ (mod n) of r (mod n); and
a unit for providing, as an output, the value V determined by said de-randomizing unit.

12. An encryption device according to claim 11, wherein said operation unit repeatedly performs the operations of:
multiplication V[1]:=V[0]×V[2] (mod n)
squaring V[2]² (mod n), and
substitution V[0]:=V[d[i]],
where V[2] indicates another variable, the value d is an m-bit sequence, and d[i] denotes a value of the i-th LSB of the value d for i=0, 1, . . . , m−1.

13. A program recorded on a recording medium for use in an information processing device and for performing elliptic encryption processing with a private key, said program being operable to effect the steps of:
generating an elliptic point R on an elliptic curve at random that is generated in accordance with a random value;
setting the elliptic point R into an initial elliptic point V₀;
performing a first operation of summing the initial elliptic point V₀ and a scalar multiple of a particular input elliptic point A on the elliptic curve, V₁=V₀+dA, in accordance with a bit sequence of a particular scalar value d for said elliptic encryption processing;
performing a second operation of subtracting the initial elliptic point V₀ from the sum V₁ determined by said first operation, V=V₁−V₀; and
providing, as an output, the elliptic point V determined by said de-randomization unit.

14. A program recorded on a recording medium for use in an information processing device and for performing modular exponentiation encryption processing with a private key,
setting, into an initial value V₀, an integer r generated in accordance with a random value;
performing a first operation of modular exponentiation V₁=V₀a^{d} (mod n)=r×a^{d} (mod n) for the initial value V₀ and a particular input value a in accordance with a bit sequence of a particular value d for said modular exponentiation encryption processing;
performing a second operation of modular multiplication V=V₁×r⁻¹ (mod n) on the value V₁ determined by said first operation and an inverse element r⁻¹ (mod n) of r (mod n); and
providing, as an output, the value V determined by said de-randomizing unit.

15. A method for use in an information processing device and for performing elliptic encryption processing with a private key, said method comprising the steps of:
generating an elliptic point R on an elliptic curve at random that is generated in accordance with a random value;
setting the elliptic point R into an initial elliptic point V₀;
performing a first operation of summing the initial elliptic point V₀ and a scalar multiple of a particular input elliptic point A on the elliptic curve, V₁=V₀+dA, in accordance with a bit sequence of a particular scalar value d for said elliptic encryption processing;
performing a second operation of subtracting the initial elliptic point V₀ from the sum V₁ determined by said first operation, V=V₁−V₀; and
providing, as an output, the elliptic point V determined by said de-randomization unit.

16. A method for use in an information processing device and for performing modular exponentiation encryption processing with a private key, said method comprising the steps of:
setting, into an initial value V₀, an integer r generated in accordance with a random value;
performing a first operation of modular exponentiation V₁=V₀a^{d} (mod n)=r×a^{d} (mod n) for the initial value V₀ and a particular input value a in accordance with a bit sequence of a particular value d for said modular exponentiation encryption processing;
performing a second operation of modular multiplication V=V₁×r⁻¹ (mod n) on the value V₁ determined by said first operation and an inverse element r⁻¹ (mod n) of r (mod n); and
providing, as an output, the value V determined by said de-randomizing unit.
